(19) United States
(12) Patent Application Publication
(10) Pub. No.: US 2023/0094506 A1
(43) Pub. Date: Mar. 30, 2023

(54) CENTRALIZED AND DECOUPLED BUILD FILE MANAGEMENT

(71) Applicant: salesforce.com, inc., San Francisco, CA (US)

(72) Inventor: Lokesh Kumar NANDAGOPAL, Bangalore (IN)

(21) Appl. No.: 17/485,970

(22) Filed: Sep. 27, 2021

(51) Int. Cl. G06Q 10/06; G06F 16/14

(52) U.S. Cl. CPC G06Q 10/06313; G06F 16/148

(57) ABSTRACT

Methods, computer readable media, and devices for centralizing and decoupling build file management. A method may include creating a common build file including a reference to one or more dependencies shared by a plurality of projects, storing the common build file in a storage location, creating a build map including a mapping between a project identifier and the storage location for at least one of the plurality of projects, receiving a request for a project-specific build file from a project, retrieving the common build file from the storage location based on a project identifier of the project and an associated build map, creating a merged build file based on the common build file and a project-specific dependency indication of the project, and sending the merged build file to the project.

### TECHNICAL FIELD

Embodiments disclosed herein relate to techniques and systems for centralizing and decoupling build files from individual projects.

### BACKGROUND

Software development projects usually have associated build files which are tightly coupled with a project. A build file usually contains any dependencies of a project as well as details about how to build the project. For example, a pom file in Maven may contain the dependencies for a Java project as well as details like how to build the final project in a .jar or .war, version details of the project, and so on. In a similar example, a NodeJS based project may have a package.json and related package-lock.json or yarn.lock files associated as build files for the project.

Typically, a language or framework may recommend to keep the build files inside the project itself and tightly couple the project and build files. This tight coupling may be recommended so that, when building a project is started, build files present inside the project may be used for downloading the dependencies, collating various project files and dependencies, and building a final version of the project. However, such tight coupling may require that project dependencies that may otherwise be common to other projects be maintained within each project specific build file. That is, if a change is made to a common dependency (e.g., updated to a new version), such change may need to be made in individual build files for all projects that reference the common dependency. Updating individual build files for 100′s of projects sharing common dependencies may be tedious and error-prone.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating a system for a traditional project-specific build.

FIG. 1B is a block diagram illustrating a system for centralizing and decoupling build files from individual projects according to some example implementations.

FIG. 2 is a flow diagram illustrating a method for predicting future performance degradation according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Embodiments disclosed herein provide techniques and systems for centralizing and decoupling build files from individual projects.

In a micro services environment, there may be hundreds of projects that all rely on numerous common dependencies associated with common frameworks utilized as part of the builds in each of these projects. Common dependencies may include, for example, an authentication and authorization framework, a database client framework, an ORM layer framework, a localization framework, or other such framework.

However, with hundreds of projects all having common framework dependencies in individual build files, maintaining these build files may become tedious and time consuming. For example, to increment a version of one framework dependency across all of these various projects, each individual build file may need to be checked out, modified, tested, and checked back in. In addition to being time consuming and tedious, this process may be error prone. Furthermore, various individual projects may also need environment specific modifications to the build file, introducing further complexity and additional potential for error.

In various implementations, a build file that may be common to a plurality of projects may be created and stored in a centralized or otherwise common storage location. In turn, a build map may be created for at least one of the individual projects. Such build map may, for example, map a project identifier of the at least one project to the build file and the build file's storage location. When a build of the at least one project is initiated, the common build file may be retrieved and merged with any project specific details to create a project specific build file. This project specific build file may then be utilized to complete the project build.

Implementations of the disclosed subject matter provide methods, computer readable media, and devices for centralizing and decoupling build file management. In various implementations, a method may include creating a common build file including a reference to one or more dependencies shared by a plurality of projects, storing the common build file in a storage location, for at least one of the plurality of projects, creating a build map including a mapping between a project identifier of the at least one of the plurality of projects and the storage location, receiving, from one project of the plurality of projects, a request for a project-specific build file including a project identifier of the one project and a project-specific dependency indication, retrieving, based on the project identifier of the one project and an associated build map, the common build file from the storage location, creating a merged build file based on the common build file and the project-specific dependency indication, and sending the merged build file to the one project.

In some implementations, the project-specific dependency indication may include one or more environment variables, the one or more environment variables set within an environment of the one project.

In various implementations, the method may further include creating a project-specific dependency file comprising a project-specific dependency and storing the project-specific dependency file in a second storage location, wherein the project-specific dependency indication may include a project-specific dependency identifier and creating the merged build file based on the common build file and the project-specific dependency indication may include retrieving the project-specific dependency file from the second storage location based on the project-specific dependency identifier and merging the common build file with the project-specific dependency file.

In various implementations, the method may further include creating a project-specific regional dependency file comprising a project-specific regional dependency specific to a region and storing the project-specific regional dependency file in a third storage location, wherein the project-specific dependency indication may further include a project-specific regional dependency identifier and creating the merged build file based on the common build file and the project-specific dependency indication may further include retrieving the project-specific regional dependency file from the third storage location based on the project-specific regional dependency identifier and merging the common build file with the project-specific dependency file and the project-specific regional dependency file.

In some implementations, the storage location is common to the plurality of projects and outside an environment of any one of the plurality of projects.

In some implementations, a project-specific dependency overrides a dependency shared by the plurality of projects.

In some implementations, a project-specific dependency may be in addition to the one or more dependencies shared by the plurality of projects.

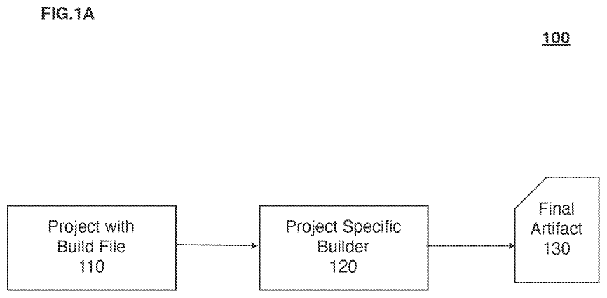

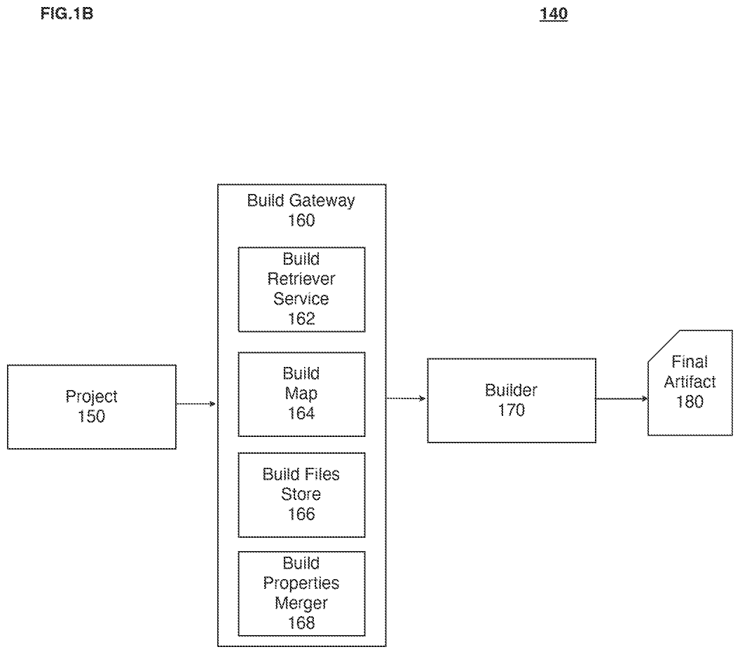

FIG. 1A illustrates a system 100 for a traditional project-specific build. In a traditional build process, a project with build file 110 may include a software development project that has a project-specific build file stored within the project. In this traditional build process, a project specific builder 120 may reference the project-specific build file stored within the project to generate final artifact 130. Final artifact 130 may, for example, be an executable or other element for implementing the project.

FIG. 1B illustrates a system 140 for centralizing and decoupling build files from individual projects according to various implementations of the subject matter disclosed herein. In various implementations, system 140 may include, for example, a project 150, build gateway 160, builder 170, and final artifact 180. Project 150 may be, for example, a software development project including various source code and/or other project related elements. In some implementations, project 150 may have various attributes associated with the project, such as a project identifier, a project version, a project build environment, project specific dependencies, and the like. These various attributes may, for example, be associated with the project via environment variables. Alternatively, or in addition, such attributes may, for example, be associated with the project via a file.

In various implementations, build gateway 160 may include, for example, build retriever service 162, build map 164, build files store 166, and build properties merger 168. When a project build is initiated, project 150 may pass or otherwise provide the various associated attributes, such as a project identifier, a project version, a project build environment, project specific dependencies, and the like, to build gateway 160. Build gateway 160 may, in turn, provide these attributes to build retriever service 162. Build retriever service 162 may, for example, retrieve a common build file from build files store 166 based on build map 164. For example, based on the project identifier, build map 164 may provide a mapping between project 150 and an associated common build file stored in build files store 166. Build properties merger 168 may, for example, merge the common build file with project specific dependencies to create a project specific build file.

In various implementations, build gateway 160 may, for example, provide the project specific build file generated by build properties merger 168 to builder 170. Builder 170 may, for example, generate final artifact 180 based on the provided project specific build file. In this way, common dependencies may be maintained in a single common build file available to a number of various projects while individual projects may also maintain project specific dependencies.

Although the various examples describe a single common build file, this is only for simplicity. Build map 164 may include, for example, multiple mappings for an individual project. As such, centralized build files may include, for example, not only a common build file for a large number of projects, but also regional specific, environment specific, or other types of specific build files. For example, a service may include a number of projects that, while generally similar, differ based on a region where the service is to be implemented (e.g., project 1 for North America, project 2 for South America, project 3 for Europe, project 4 for Asia, etc.), with each region having different region-specific dependencies. In addition, dependencies may differ based on whether a project is to be built for a different environment (e.g., testing, staging, production, etc.). In this example, there may be a single common build file for all projects in the service as well as region specific files for the various regions and/or environment specific files for the various environments. In some implementations, that various build files may be, for example, hierarchal in nature. That is, environment specific files, for example, may be considered children of a common build file while region specific files, for example, may be considered children of an environment specific file and grandchildren of a common build file. Based on a project identifier and an associated mapping, build map 164 may be able to provide information about all of the necessary build files to build retriever service 162 and build retriever service 162 may be able to retrieve all of these build files from build files store 166. Build properties merger 168 may than be able to merge the various build files and any project specific dependencies into a project specific build file.

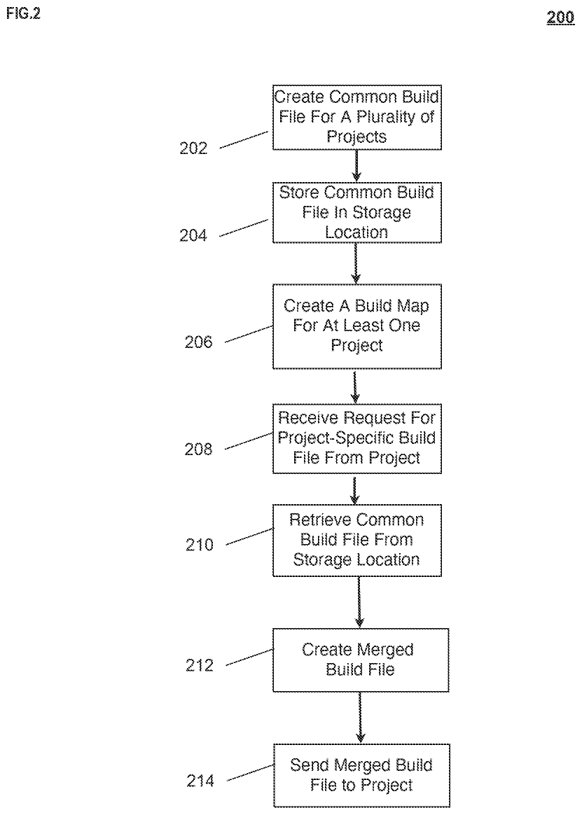

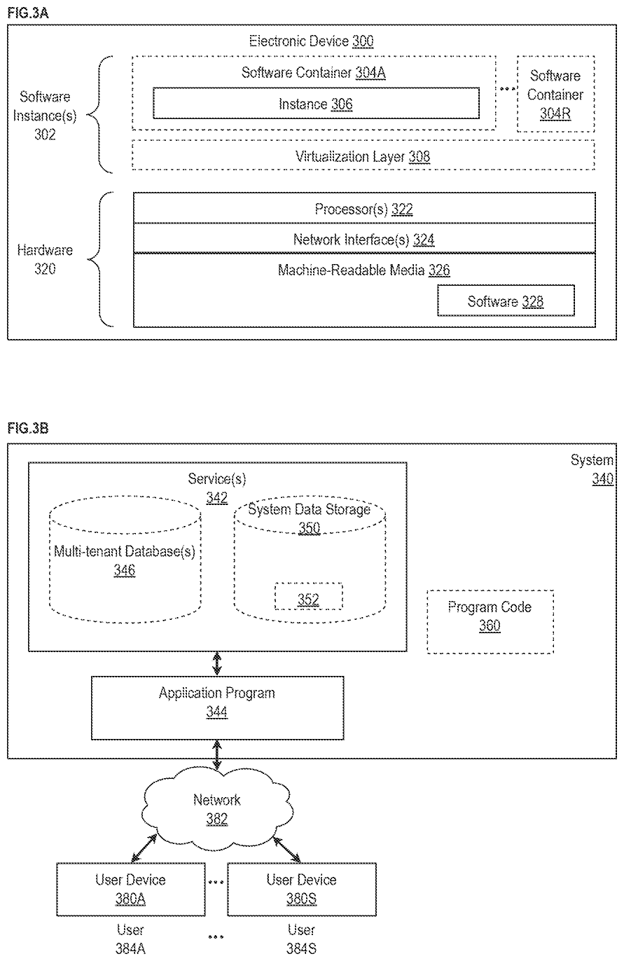

FIG. 2 illustrates a method 200 for centralizing and decoupling build files from individual projects, as disclosed herein. In various implementations, the steps of method 200 may be performed by a server, such as electronic device 300 of FIG. 3A or system 340 of FIG. 3B, and/or by software executing on a server or distributed computing platform. Although the steps of method 200 are presented in a particular order, this is only for simplicity.

In step 202, a common build file for a plurality of projects may be created. In various implementations, the common build file may include, for example, one or more dependencies shared by the plurality of projects. A dependency may include, for example, a common authentication and authorization framework, a database client framework, an ORM layer framework, a localization framework, or the like. The one or more dependencies may be common, for example, in that more than one project relies on the one or more dependencies.

In step 204, the common build file may be stored in a storage location. In various implementations, the storage location may be, for example, a centralized or other location distinct and separate from any one project. That is, the storage location may be common to or otherwise accessible by the plurality of projects. The storage location may be, for example, a data store, a database, a file, or any other type of storage. Although the storage location may be common to or otherwise accessible by a plurality of projects, such location may be distributed, such as across a plurality of data stores, databases, files, other storage types, or any combination of such storage.

In step 206, a build map for at least one project may be created. In various implementations, a build map may provide, for example, a mapping between a project and a common build file. A build map may include, for example, a project identifier of an associated project and a storage location of a common build file to be associated with the project. For example, the common build file may be the common build file created in step 202 and the storage location may be the storage location from step 204 in which the build file was stored. As such, in step 206, a build map may be created, for example, for any project that may be associated with a common build file. While various projects may share a common build file stored in a commonly accessible location, any one project will have a unique build map because a project identifier is unique to a project.

Although a build map is described as mapping a project to a single common build file in the various examples, this is only for simplicity. A build map may, for example, map a project identifier to more than one common build file and such plurality of build files may include alternative and/or cumulative build files. For example, a project may utilize one common build file when building the project for a development environment and a different common build file when building the project for a production environment. Similarly, a project may utilize both a common build file (based on the build environment) as well as, for example, a regional specific build file depending on which region the project is being built. As such, a build map for a project may provide, for example, a map to multiple build files.

In step 208, a request for a project-specific build file may be received from a project. In various implementations, the request may include, for example, a project identifier, a version, a language or framework being used, a build environment (e.g., development, testing, production, etc.), an indication of project specific dependencies, and the like. Project specific dependencies may be, for example, dependencies that are specific to the project making the request. Such project specific dependencies may be in addition to dependencies included in a common build file and/or may override or otherwise provide an alternative to one or more dependencies in the common build file. In some implementations, project-specific dependencies may be provided, for example, as environment variables defined within a project build environment and the indication of project specific dependencies may be a pointer to or other indication of the project build environment. In some implementations, project specific dependencies may be provided, for example, within a project-specific dependency file and the indication of project-specific dependencies may be a project-specific dependency identifier.

In step 210, a common build file may be retrieved from a storage location. In various implementations, the common build file may be retrieved, for example, based on the project identifier provided as part of the request received in step 208. For example, a build map including the received project identifier may be referenced to determine a storage location and the common build file may be retrieved from the storage location. Although various examples refer to a single common build file, this is only for simplicity. For example, a common build file may be retrieved in addition to a project-specific dependency file and/or a project-specific regional dependency file.

In step 212, a merged build file may be created. In various implementations, the merged build file may be based, for example, on the common build file retrieved in step 210 and any project-specific dependencies provided as part of the request in step 208. As such, while the merged build file may be based on a common build file, the merged build file may be a project-specific build file that includes details specific to the project being built.

In step 214, the merged build file may be sent to the project. In various implementations, the merged build file may be sent to the project by storing the merged build file in a local storage of the build environment. Once the project is built, the merged build file may, for example, be removed from the local storage.

As disclosed herein, centralizing and decoupling build files from individual projects may be achieved. By centralizing and decoupling build files, build file management may be enhanced by reducing the number of individual files that need to be manually edited and, thereby, reducing the potential for errors. Unlike a traditional approach to building a project wherein a project-specific build file is stored within the project, the project-specific build file may be created on demand and provided to the build process as described herein.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method for centralizing and decoupling build file management, the method comprising:
creating a common build file comprising a reference to one or more dependencies shared by a plurality of projects;
storing the common build file in a storage location;
for at least one of the plurality of projects, creating a build map including a mapping between a project identifier of the at least one of the plurality of projects and the storage location;
receiving, from one project of the plurality of projects, a request for a project-specific build file, the request comprising:
a project identifier of the one project; and
a project-specific dependency indication;
retrieving, based on the project identifier of the one project and an associated build map, the common build file from the storage location;
creating a merged build file based on the common build file and the project-specific dependency indication; and
sending the merged build file to the one project.

2. The computer-implemented method of claim 1, wherein the project-specific dependency indication comprises one or more environment variables, the one or more environment variables set within an environment of the one project.

3. The computer-implemented method of claim 1, further comprising:
creating a project-specific dependency file comprising a project-specific dependency; and
storing the project-specific dependency file in a second storage location,
wherein:
the project-specific dependency indication comprises a project-specific dependency identifier; and
creating the merged build file based on the common build file and the project-specific dependency indication comprises:
retrieving the project-specific dependency file from the second storage location based on the project-specific dependency identifier; and
merging the common build file with the project-specific dependency file.

4. The computer-implemented method of claim 3, further comprising:
creating a project-specific regional dependency file comprising a project-specific regional dependency specific to a region; and
storing the project-specific regional dependency file in a third storage location,
wherein:
the project-specific dependency indication further comprises a project-specific regional dependency identifier; and
creating the merged build file based on the common build file and the project-specific dependency indication further comprises:
retrieving the project-specific regional dependency file from the third storage location based on the project-specific regional dependency identifier; and
merging the common build file with the project-specific dependency file and the project-specific regional dependency file.

5. The computer-implemented method of claim 1, wherein the storage location is common to the plurality of projects and outside an environment of any one of the plurality of projects.

6. The computer-implemented method of claim 1, wherein a project-specific dependency overrides a dependency shared by the plurality of projects.

7. The computer-implemented method of claim 1, wherein a project-specific dependency is in addition to the one or more dependencies shared by the plurality of projects.

8. A non-transitory machine-readable storage medium that provides instructions that, if executed by a processor, are configurable to cause the processor to perform operations comprising:
creating a common build file comprising a reference to one or more dependencies shared by a plurality of projects;
storing the common build file in a storage location;
for at least one of the plurality of projects, creating a build map including a mapping between a project identifier of the at least one of the plurality of projects and the storage location;
receiving, from one project of the plurality of projects, a request for a project-specific build file, the request comprising:
a project identifier of the one project; and
a project-specific dependency indication;
retrieving, based on the project identifier of the one project and an associated build map, the common build file from the storage location;
creating a merged build file based on the common build file and the project-specific dependency indication; and
sending the merged build file to the one project.

9. The non-transitory machine-readable storage medium of claim 8, wherein the project-specific dependency indication comprises one or more environment variables, the one or more environment variables set within an environment of the one project.

10. The non-transitory machine-readable storage medium of claim 8, wherein the operations further comprise:
creating a project-specific dependency file comprising a project-specific dependency; and
storing the project-specific dependency file in a second storage location,
wherein:
the project-specific dependency indication comprises a project-specific dependency identifier; and
creating the merged build file based on the common build file and the project-specific dependency indication comprises:
retrieving the project-specific dependency file from the second storage location based on the project-specific dependency identifier; and
merging the common build file with the project-specific dependency file.

11. The non-transitory machine-readable storage medium of claim 10, wherein the operations further comprise:
creating a project-specific regional dependency file comprising a project-specific regional dependency specific to a region; and
storing the project-specific regional dependency file in a third storage location,
wherein:
the project-specific dependency indication further comprises a project-specific regional dependency identifier; and
creating the merged build file based on the common build file and the project-specific dependency indication further comprises:
retrieving the project-specific regional dependency file from the third storage location based on the project-specific regional dependency identifier; and
merging the common build file with the project-specific dependency file and the project-specific regional dependency file.

12. The non-transitory machine-readable storage medium of claim 8, wherein the storage location is common to the plurality of projects and outside an environment of any one of the plurality of projects.

13. The non-transitory machine-readable storage medium of claim 8, wherein a project-specific dependency overrides a dependency shared by the plurality of projects.

14. The non-transitory machine-readable storage medium of claim 8, wherein a project-specific dependency is in addition to the one or more dependencies shared by the plurality of projects.

15. An apparatus comprising:
a processor; and
a non-transitory machine-readable storage medium that provides instructions that, if executed by a processor, are configurable to cause the processor to perform operations comprising:
creating a common build file comprising a reference to one or more dependencies shared by a plurality of projects;
storing the common build file in a storage location;
for at least one of the plurality of projects, creating a build map including a mapping between a project identifier of the at least one of the plurality of projects and the storage location;
receiving, from one project of the plurality of projects, a request for a project-specific build file, the request comprising:
a project identifier of the one project; and
a project-specific dependency indication;
retrieving, based on the project identifier of the one project and an associated build map, the common build file from the storage location;
creating a merged build file based on the common build file and the project-specific dependency indication; and
sending the merged build file to the one project.

16. The apparatus of claim 15, wherein the project-specific dependency indication comprises one or more environment variables, the one or more environment variables set within an environment of the one project.

17. The apparatus of claim 15, wherein the operations further comprise:
creating a project-specific dependency file comprising a project-specific dependency; and
storing the project-specific dependency file in a second storage location,
wherein:
the project-specific dependency indication comprises a project-specific dependency identifier; and
creating the merged build file based on the common build file and the project-specific dependency indication comprises:
retrieving the project-specific dependency file from the second storage location based on the project-specific dependency identifier; and
merging the common build file with the project-specific dependency file.

18. The apparatus of claim 17, wherein the operations further comprise:
creating a project-specific regional dependency file comprising a project-specific regional dependency specific to a region; and
storing the project-specific regional dependency file in a third storage location,
wherein:
the project-specific dependency indication further comprises a project-specific regional dependency identifier; and
creating the merged build file based on the common build file and the project-specific dependency indication further comprises:
retrieving the project-specific regional dependency file from the third storage location based on the project-specific regional dependency identifier; and
merging the common build file with the project-specific dependency file and the project-specific regional dependency file.

19. The apparatus of claim 15, wherein the storage location is common to the plurality of projects and outside an environment of any one of the plurality of projects.

20. The apparatus of claim 15, wherein a project-specific dependency overrides a dependency shared by the plurality of projects.
